(19) United States
(12) Patent Application Publication
(10) Pub. No.: US 2011/0131100 A1
(43) Pub. Date: Jun. 2, 2011

(54) Outside-in social network communication and promotion

(76) Inventors: Harry R. Soza, San Jose, CA (US); Mark Wayman, Oakland, CA (US); Keith Rose, Alamo, CA (US); Jeffrey A. Roberts, Hayward, CA (US)

(21) Appl. No.: 12/804,248

(22) Filed: Jul. 16, 2010

Related U.S. Application Data
(63) Continuation-in-part of application No. 12/288,614, filed on Oct. 21, 2008.
Application No. 12/288,614 is a continuation-in-part of application No. 12/460,223, filed on Jul. 14, 2009.
(60) Provisional application No. 61/271,600, filed on Jul. 22, 2009.

(51) Int. Cl. G06Q 30/00

(52) U.S. Cl. 705/14.73

(57) ABSTRACT

A system for spreading promotional content into a social network environment from outside the social network is provided. A computer server system monitors information associated with the promotional content and the communication steps associated with the outside-in communication and further inside communications or spread of the promotional content.

### CROSS-REFERENCE TO RELATED APPLICATIONS

This application claims priority from U.S. Provisional Patent Application 61/271,600 filed Jul. 22, 2009, which is incorporated herein by reference. This application is a continuation-in-part of U.S. patent application Ser. No. 12/288,614 filed Oct. 21, 2008, which is incorporated herein by reference. This application is a continuation-in-part of U.S. patent application Ser. No. 12/460,223 filed Jul. 14, 2009, which is incorporated herein by reference.

### FIELD OF THE INVENTION

The invention relates generally to online promotions. More particularly, the invention relates to computer-based systems and methods of promotional offers in an online environment initiated outside a social network computer-based system, brought into a social network computer-based system, and spread inside the social network computer-based system.

### BACKGROUND OF THE INVENTION

Social networks (SNs) are technology systems that enable and stimulate extraordinary levels of almost frictionless communication between groups of individuals who have some form of social relationship. These relationships can be relatives, friends, colleagues, co-workers, etc.

One important dynamic of this very-easy-to-use communication is “viral spread”, which is a situation where an electronic word-of-mouth topic gets passed to an ever-increasing audience in a short timeframe. Through viral spread a single topic of conversation can be passed from one group of recipients to their friends, then to the friends of those recipients and so on. There are cases where a single topic has reached millions of individuals in only a few hours.

A key component of viral spread is that it is entirely voluntary. One person decides whether or not to share a topic of information with their friends and which/how many friends they want to message. This constitutes a personal value judgment about whether or not to send a message to specific friends.

In the non-SN Internet, businesses and causes have well-established mechanisms for reaching an audience. Today, companies and organizations are using methods such as search engine optimization (SEO), email blasts, postings to websites, YouTube videos, blogs, press releases, periodic newsletters, affiliation agreements, and many others to reach their audience. These methods can be categorized as “awareness methods”, whereby the Internet is used to reach an audience with promotions about news or offers. To support these non-SN methods, extensive data capture and data mining methods have been developed to measure the effectiveness and return-of-investment (ROI) of the method being employed.

### SUMMARY OF THE INVENTION

What has been strongly desired by virtually every promotional effort is new technology to somehow incorporate the viral spread dynamic of social networks into the established promotional methods that operate in the non-SN Internet. This is an “outside-in” solution, where a user can begin “outside” (i.e. in the non-SN Internet) and readily move “inside” the SN to utilize the powerful communications and viral spread capabilities of the SN. It is also required that this technology have an inherent form of data capture and data mining that is specific to viral spread dynamic, so that the ROI of the promotional effort can be measured. The invention presented herein is precisely this sort of technology solution.

### BRIEF DESCRIPTION OF THE DRAWINGS

FIGS. 1-3 shows exemplary embodiment(s) of the present invention.

### DESCRIPTION OF THE INVENTION

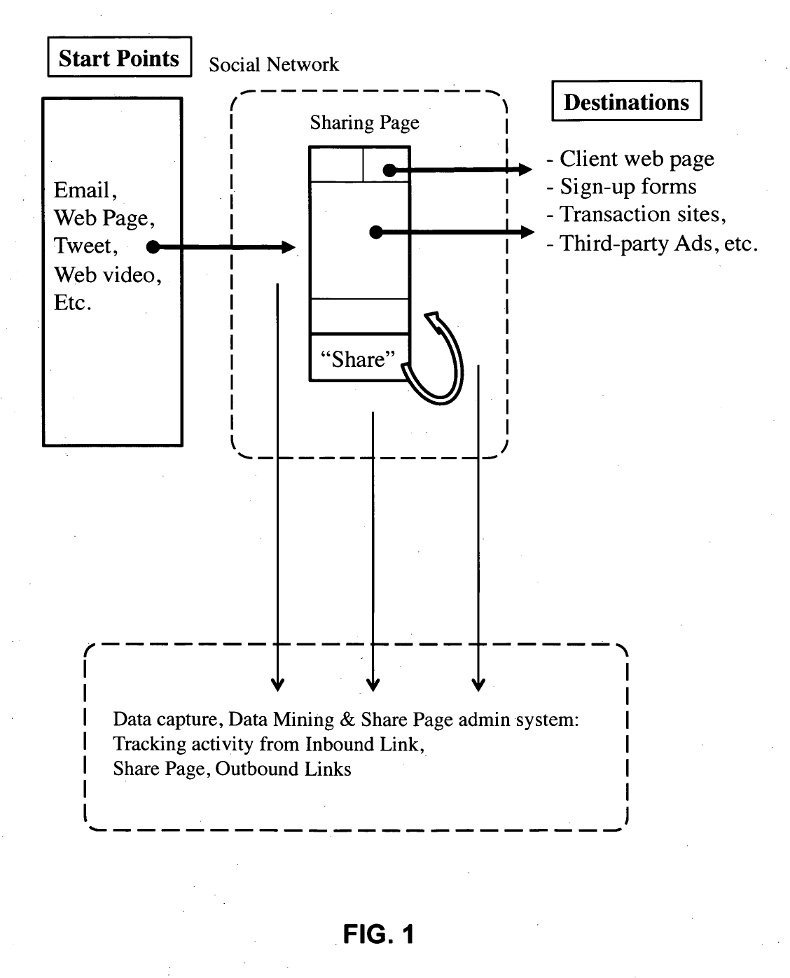

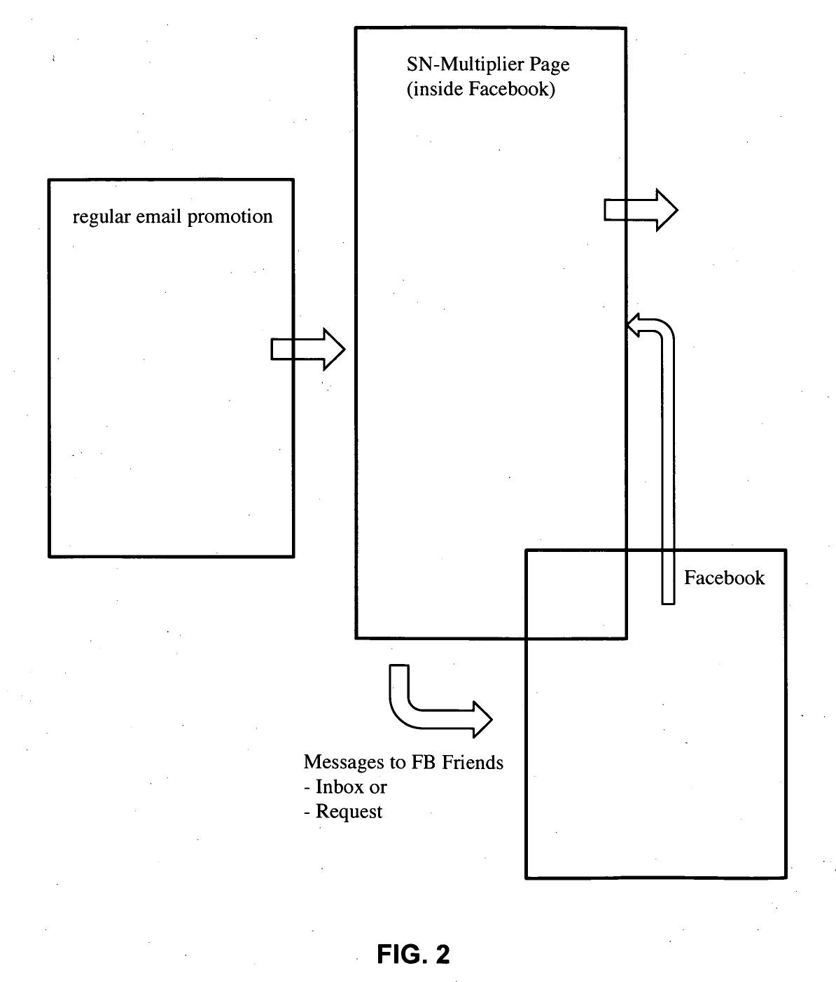

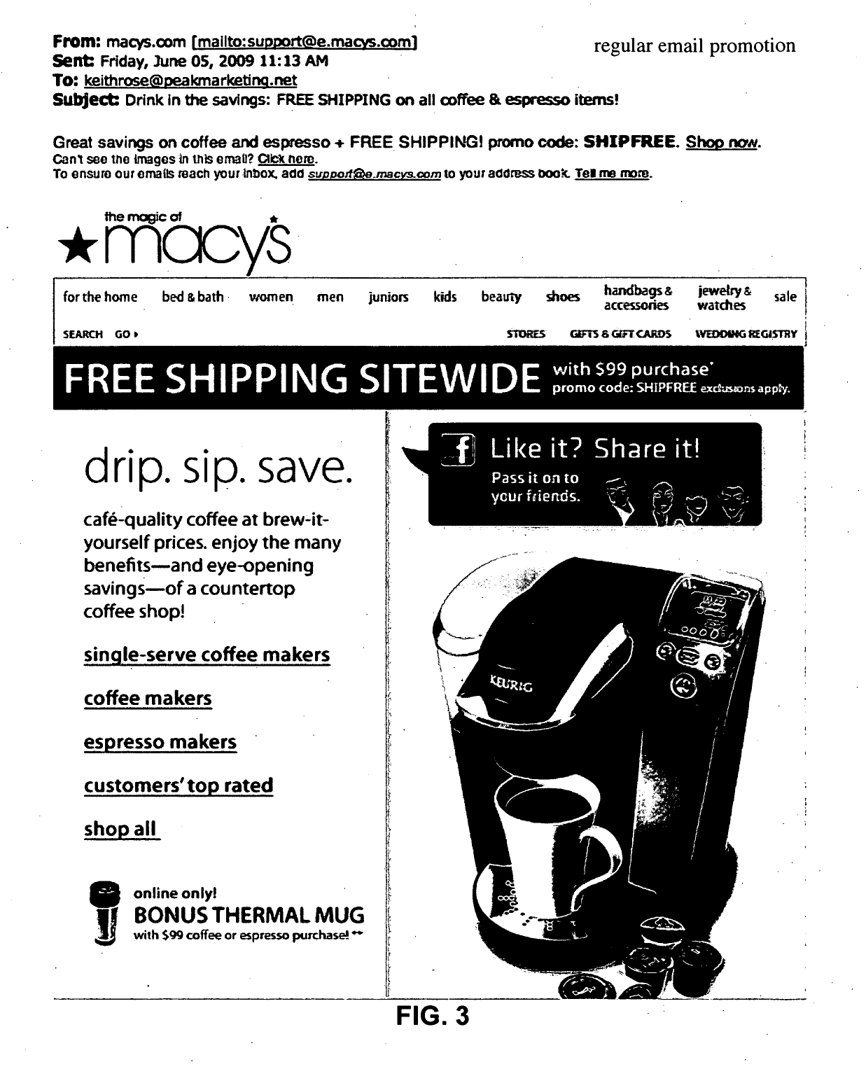

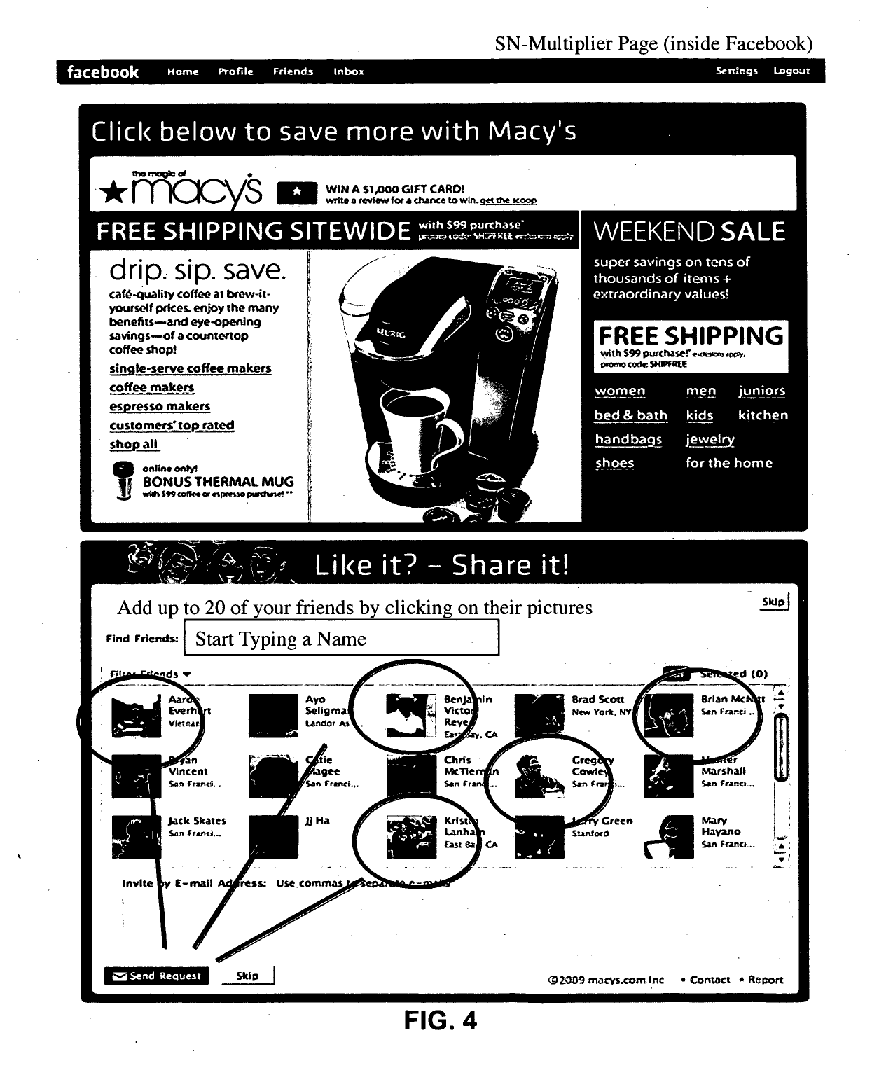

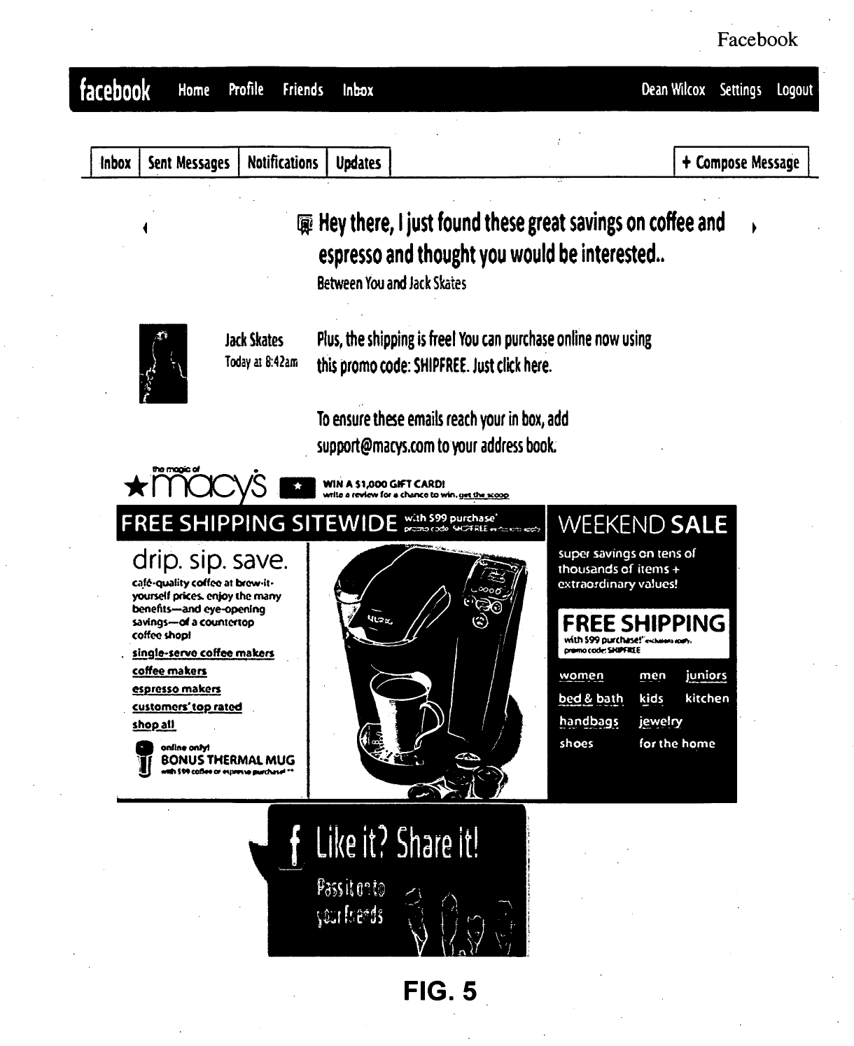

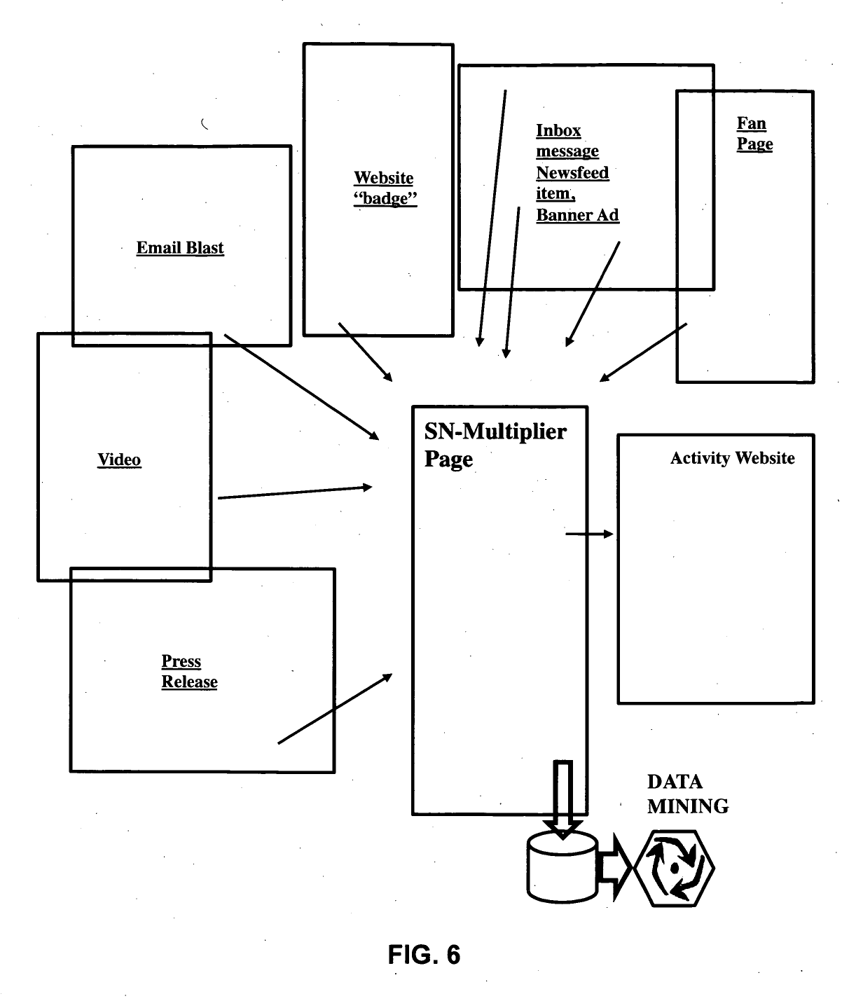

FIGS. 1-3 show different computer-based and implemented systems and methods that encompass embodiments of the invention. In one example, a regular email promotion has been initiated for example by Macy's. The email sent by a computer server by Macy's or on behalf of Macy's reaches an audience by email. The email could be an HTML formatted email including promotional items or information that Macy's wants to share. One of the key aspects of the invention is the addition of a specific link in that HTML email illustrated by a graphic indicating “Like it? Share it!”. This graphic represents the link that if clicked takes the email recipient who wishes to share the content of the Macy's email into a specific SN system/environment of which the email recipient is a member. In the process of going from the outside-SN Internet to inside the SN of the recipient, specific information can be captured about the email recipient along with the information about the content of the email. This is accomplished, for example, by adding a specially coded character string to the URL of the “Like It? Share It?” link. At the Internet page to which the URL was directed, the character string can be recorded and interpreted as a unique identifier of this email recipient's actions and the content to which they are responding. In other words, the identifier can provide the email identity and other information of the person that initiated bringing the Macy's email content into SN system environment.

In the SN environment, content equivalent to the original the Macy's email is now displayed (e.g. in a SN Multiplier page), along with social network friends of the person, which is familiar to the user because it is similar in design and style to other pages inside the SN. In addition, this page contains all the standard SN communication methods that are familiar to and can be utilized by the SN member.

In addition to the Macy's content, this page includes a graphic to remind the user to share the promoted information with their friends. The user of that social network can identify one or more friends and click the “send” button, which causes a message about the Macy's content to be shared among the friends. Likewise when a friend receives the Macy's information, he/she can act on the message, arrive at a page similar to that of the original sender, and share that with their friends in the SN network. In other words, the Macy's information initiated from outside the SN environment and brought into the SN environment has become subject to viral spread.

The invention provides a computer system capable of enabling a user to start from a non-SN Internet page, email or other type of non-SN Internet presence, and then readily enter into a SN of which they are a member. Once inside the SN environment, the user (SN member) can utilize the SN's communications methods to send specific messages about the promoted content to selected friends.

Embodiments of the invention further provide a computer system that can track the activity details and identity of:

a) the user who sent the messages,
b) how many messages were sent,
c) the recipients to whom the messages were sent,
d) which recipients responded (took the desired action) to the message they received,
e) which inviter sent the specific message that caused a recipient to respond,
f) or any number of correlated statistics about the above actions.

Embodiments of the invention further provide a computer system capable of tracking the ongoing spread of information across multiple generations of sharing: from one generation of users who send messages about a specific topic to their friends, who then send it to their friends, who then send it to their friends, etc . . .

Embodiments of the invention also provide a data analysis systems capable of assessing the quality and degree of this multi-generational pattern of information sharing and assigning quantified values to the viral spread that has been observed.

Still embodiment of the invention provide a computer system capable of maintaining a database of users with regard to their “influence” in specific domains; that is, the ability to identify and quantify a user's influence in getting their friends to act on a message that they send to their friends about a specific topic.

Still embodiment of the invention provide a messaging management system capable of supporting multivariate testing of messaging content and format, so that various promotional techniques can be tested as to their comparative ability to induce viral spread and achieve the desired results of the promotion.

Embodiments of the invention can be a computer-implemented method or system. It also includes one or more digital storage media tangibly embodying machine-readable instructions executable by a computer or computer server, whereby the instruction entail at least some of the methods and systems of this invention.

In one variation, one embodiment pertains to where display ads often appear on web pages via an Ad Server, a technology company that maintains a library of Ads (uploaded by Advertisers) that it dynamically inserts into display areas on cooperating websites. The specific ads that are selected to be displayed are algorithmically chosen, typically based on the primary content that the host web page is displaying at the time. For example, if a web page is showing information about camping sites, then the Ad Server might select to display an ad about hiking boots. It would be advantageous if such a dynamically selected ad could connect to a social sharing capability, and thus be able to be readily passed along by viewers.

1. A system for spreading promotional content into a social network environment, comprising:
(a) a first communication network system being a social network communication system with a plurality of social network members and friends;
(b) a second communication network system being a communication network outside said social network communication system; and
(c) a user of said second communication network receiving a communication containing a promotional item;
(d) said user initiating a first communication from said second communication network system to inside said first communication network system, wherein said user is a member of said social network communication system and has connections to social network friends in said social network communication system;
(e) further communicating in a second communication said promotional item to said social network friends;
(f) each of said friends capable of initiating a third communication from said first communication network to the friends of each of said friends in said social network communication system; and
(g) a computer server system monitoring information associated with said promotional item and said first, second and third communication steps.
